(19) United States
(12) Patent Application Publication
(10) Pub. No.: US 2004/0188998 A1
(43) Pub. Date: Sep. 30, 2004

(54) Drug calendar apparatus and method

(76) Inventor: David A. Henthorn, Carmel, IN (US)

Correspondence Address: Bose McKinney & Evans, Intellectual Property Group, Suite 2700, 135 North Pennsylvania Street, Indianapolis, IN, 46204, US

(21) Appl. No.: 10/484,130

(22) PCT Filed: Jul. 18, 2002
(86) PCT No.: PCT/US02/22892

Related U.S. Application Data
(60) Provisional application No. 60/306,603, filed on Jul. 19, 2001.

(51) Int. Cl. B42D 15/00

(52) U.S. Cl. 283/900

(57) ABSTRACT

The present invention relates to a medication reminder and compliance method and apparatus (10). A date specific calendar including daily dosage information is generated as a label (62, 66) or information sheet (60, 67).

### BACKGROUND AND SUMMARY OF THE INVENTION

The present invention relates to the field of reminder devices and compliance records for prescription and “over the counter” medications. Illustratively, one embodiment of the reminder device is in the form of a calendar, grid, or list that is printed on a label that is customarily affixed to the container in which a prescription or other medication is dispensed. In another illustrated embodiment of the present invention, the reminder device is incorporated onto an information sheet that customarily accompanies prescriptions.

The calendar or grid can be day of the week, date of the month, and/or time of day specific to the patient and specific to the medication as prescribed by the physician. In other words, the instructions given by the physician are displayed in a calendar, grid or list format, on the label affixed to the container, with as much detail as the physician recommends. The calendar or grid is custom made for the specific patient and medications.

The present invention provides a calendar, grid, or list on the label and/or the information sheet, which serves as a visual representation of the last dosage taken and the time when the next dosage is due to be taken. The present invention can also be applied to over the counter “OTC” medications. For the purposes of the present invention OTC medications include any non-prescription medicine, vitamin, or supplement intended to enhance the health of a customer or patient. The present invention serves as a reminder for the patient to take the drug or medication as recommended and also serves as a compliance record. Through various embodiments, the patient marks on the calendar or grid as medication is taken. If the medication is ineffective, the compliance record can assist the physician in determining if a lack of compliance contributed to the ineffectiveness of the medicine.

Most medications, whether prescribed by a physician or an OTC medicine, are more effective when taken at the right times as recommended or prescribed by the doctor, pharmacist, and/or the pharmaceutical company. Compliance with these instructions allows the patient the best opportunity for the medication to have its full desired effect. Many medications can be harmful, or their effectiveness lessened, if taken other than prescribed.

Patients sometimes worry whether or not they have taken their medicine properly. Many patients have difficulty recalling whether they have taken their most recently scheduled dose. If the patient is not sure about a dose of medication, then he/she may be afraid to take another dose because they fear either overmedication or undermedication. This problem can be an annoyance or it can be a serious concern, depending on the medication involved. With antibiotics, if the course of treatment is not followed, the effectiveness of the medication may be impaired and the infection may not be cured. Another example is oral insulin. With this medication, very serious health effects can occur if 1) not enough insulin is taken or 2) if too much insulin is taken. Thus it is not uncommon for a person to be concerned because he/she cannot remember for sure if they took their medication as prescribed.

The present invention reduces a patient's worry because it provides a compliance record on the label and/or the information sheet. If a patient does not attain the desired result with the medication, the patient, doctor, and pharmacist can view the label and/or information sheet to see the patient's compliance record with the medication schedule. The compliance (or lack of compliance) may be instrumental in helping to determine the best course of action for the patient.

The present invention is inexpensive because it utilizes already existing materials that are customarily included in the prescription industry (i.e. labels and information sheets). The present invention makes these components significantly more effective by communicating the desired message of instruction and it enhances the patient's compliance with those instructions.

The present invention makes full compliance more likely to be achieved by the patient. A patient is therefore more likely to take the full run of medication since a compliance record is being kept. A patient will be less likely to take any “expired” medication if it is clearly shown on the label the full instructions including day, date and time of the recommended dosages. It will reinforce the expired state of the medicine.

According to an illustrated embodiment of the present invention, a medication reminder and compliance method comprises generating information related to a medication to be taken by a person, generating a calendar including daily dosage information for specifically identified days, and combining the calendar and the medication information on a single sheet to be referenced by the person.

According to another illustrated embodiment of the present invention, a medication reminder and compliance method comprises selecting a number of days duration that a person is scheduled to take a medication, selecting a start date for the medication, selecting a number of doses of the medication to be taken by the person each day, and generating a date specific calendar including daily dosage indicators for each day for the medication based on the selected steps.

The illustrated method further comprises the step of identifying any of the days which require an altered daily dosage, and modifying the daily dosage for each day identified during the identifying step. The calendar illustratively includes indicia useable by the person to indicate when particular medication dosages are taken as scheduled. The indicia illustratively includes at least one a plurality of check boxes, time of day designations, punch-out portions, peel-off portions, and scratch-off portions.

According to yet another illustrated embodiment of the present invention, a medication reminder and compliance apparatus comprises means for selecting a number of days duration that a person is scheduled to take a medication, means for selecting a start date for the medication, means for selecting a number of doses of the medication to be taken by the person each day, and means for generating a date specific calendar including daily dosage indicators for each day for the medication is scheduled to be taken.

### BRIEF DESCRIPTION OF THE DRAWINGS

The detailed description particularly refers to the accompanying figures in which:

FIG. 1 is a diagrammatic view of the drug calendar generation apparatus of the present invention;

FIGS. 2 and 3 are flowcharts illustrating the steps performed by the system of the present invention to generate a calendar, grid, or list containing information about specific daily dosages of a medication;

FIG. 4 is an illustrated display screen on the computer of the present invention showing a sample label to be printed;

FIG. 5 illustrates a label on a medication bottle;

FIG. 6 illustrates another embodiment of a label being applied to a medication bottle;

FIG. 7 illustrates a calendar located within a medication box;

FIG. 8 illustrates a calendar and instruction sheet in accordance with another embodiment of the invention; and

FIGS. 9-13 illustrate alternative embodiments for marking portions of the calendar, grid or list to indicate that a particular dosage of medication has been taken.

### DETAILED DESCRIPTION OF THE DRAWINGS

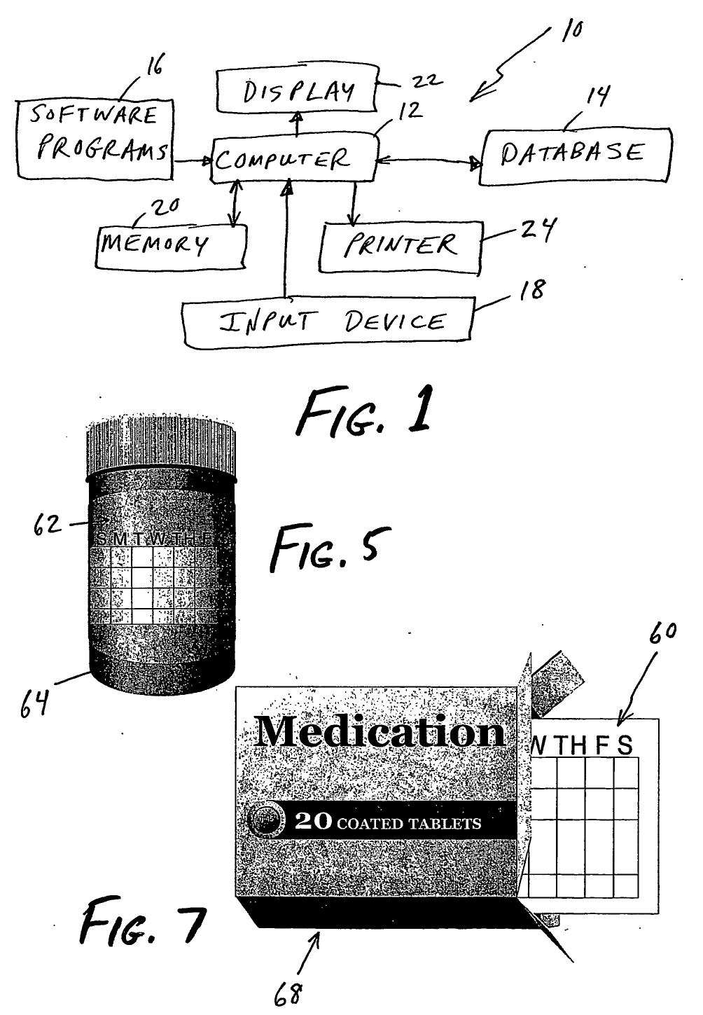

U.S. Provisional Application Serial No. 60/306,603 is hereby incorporated by reference. Referring now to the drawings, FIG. 1 illustrates a drug calendar apparatus 10 of the present invention in which a pharmacist or assistant utilizes a computer 12 coupled to a database 14 of drug information and software programs 16 to integrate the calendar style format into the process of producing and printing a label and/or information sheet. The pharmacist or assistant enters basic prescription or over the counter “OTC” medication information into the computer 12 using an input device 18 such as a keyboard, mouse, a touch screen, joystick, voice recognition software, or the like. This information illustratively includes the areas listed below, but is not to be limited to these areas of information:

1. patient information

2. prescribing doctor's information

3. drug name and information

4. dosage instructions

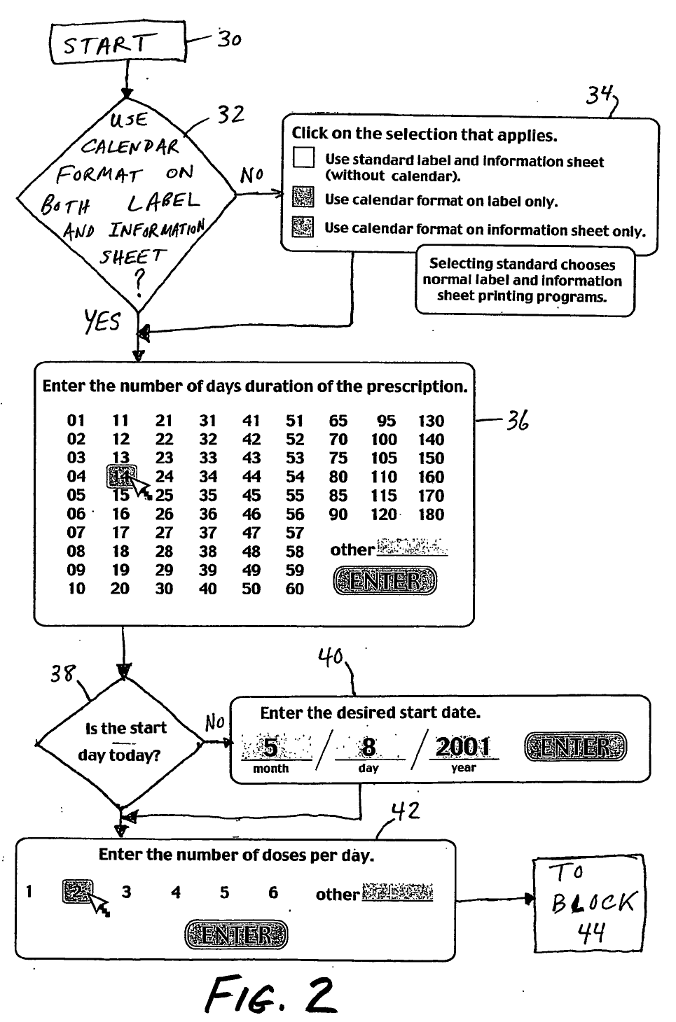

The computer 12 includes a microprocessor, a conventional memory 20 and a display 22. Computer 12 is also coupled to a printer 24 which prints labels and/or information sheets as discussed below. The software takes the pharmacy worker through a series of questions or steps to layout the calendar format as illustrated in FIGS. 2 and 3.

The computer 12 is illustratively programmed with software to perform the steps illustrated in FIGS. 2 and 3. The program starts at block 30 in FIG. 2. The computer 12 displays a prompt to ask the operator whether the calendar format should be used on both the label and the information sheet as illustrated at block 32. If not, computer 12 illustratively displays a selection box to permit the operator to select generating a standard label and information sheet (without the calendar), a calendar format on the label only, or generating a calendar format on the information sheet only. This step is illustrated at block 34. If the standard label and information sheet is requested, the label and information sheet are printed in a conventional manner.

If it is desired to use the calendar format on one or both of the label and information sheet, computer 12 proceeds to block 36 and prompts the operator to enter the number of days duration of the prescription or OTC medication. Illustratively, the program may default to the most common dosage duration for the drug or medication being described. The program may display a menu of days or permit manual entry of the number of days, or both.

Once the number of days is entered at block 36, the computer 12 displays a prompt to ask the user whether the start date for the prescription is today as illustrated at block 38. If not, the computer 12 prompts the user to enter the desired start date as illustrated at block 40. Once the start date is determined, computer 12 proceeds to block 42 and displays a prompt to ask the user to enter the number of doses per day. Illustratively, the computer 12 may default to the most common daily dosage for the drug or medication being prescribed. The program then allows an alternative number of dosages to be entered, if needed.

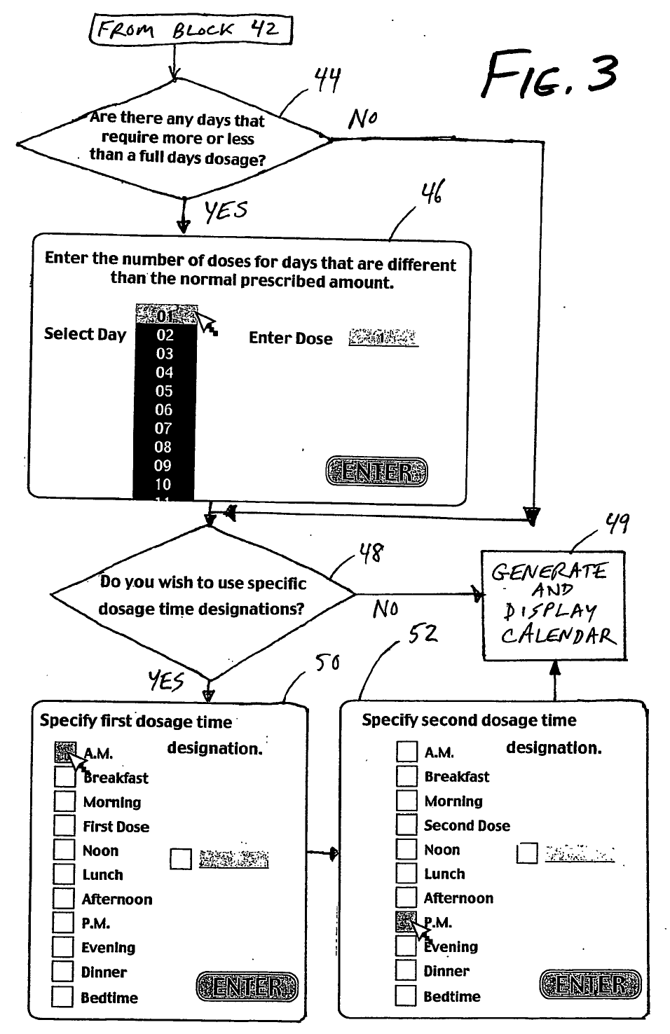

After the number of daily doses is entered at block 42, the computer 12 displays a prompt to ask the user whether there are any days that require more or less than a full day's dosage as illustrated at block 44 and FIG. 3. If so, the computer prompts the operator to enter the number of doses for specific days that are different than the normal prescribed dosage. The operator enters the selected day and then enters the modified dosage at block 46. For example, a prescription that is filled late in the day may require less medication for the first day, since it is a partial day. See the entry for Tuesday, May 8, in FIG. 4, for example. In addition, certain drugs, such as antibiotics may require double doses in the early days of the prescription.

Next, the computer 12 displays a prompt to ask the operator whether specific dosage time designations are desired. If not, computer 12 generates and displays the label and/or information sheet for review by the operator as illustrated in FIG. 4.

If the operator requests to use specific dosage time designations at block 48, computer 12 permits the operator to enter designated times for taking each daily dose of the medication. For example, the first dosage time designation is specified at block 50, and the second dosage time designation is specified at block 52. Additional daily doses can be designated using similar designation screens. The number of dosages designated corresponds to the number of doses selected at block 42. The operator can then modify or print the label or information sheet. Once all the daily dosage times are designated, the computer 12 proceeds to block 49 and generates and displays the label or information sheet.

These dosage time descriptions illustrated in blocks 50 and 52 are examples of what can be used. The pharmacist can input any time designation including those that are not listed in blocks 50 and 52. Those skilled in the art recognize that any description that may be appropriate to help patients adhere to the dosage schedule may be used. These descriptions may vary from one pharmacist to the next and from on patient to the next.

FIG. 4 illustrates one embodiment of a calendar grid of the present invention. Illustratively, computer 12 displays the grid on the display to allow the pharmacy worker to review and make changes to the grid before printing.

Output options for the calendar format include but are not limited to:

1. An information sheet 67 to accompany the prescription or OTC medication as shown in FIG. 7.

2. A calendar that is accessed by the patient/customer via a home computer. In this embodiment, the customer/patient can view their calendar online and keep compliance records “on line” or print out the calendar and keep track of compliance on paper. In this embodiment, the customer accesses a remote website using the customer's computer. The customer can answer a series of questions similar to those in FIGS. 2 and 3 to generate his or her own calendar or information sheet. As discussed above, the customer can print the calendar or information sheet for manual use or can update the compliance records online, if desired.

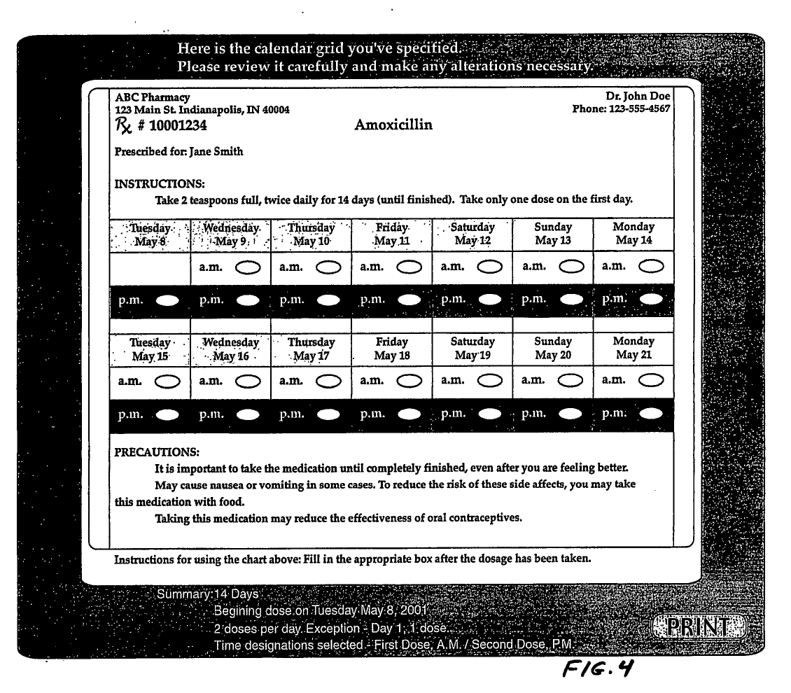

3. A label 62 for a prescription bottle 64 or vial shown in FIGS. 5 and 6.

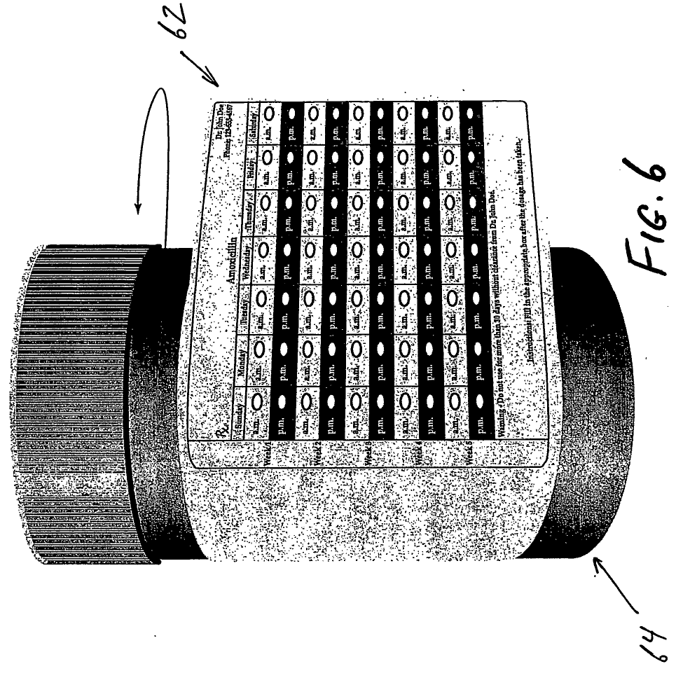

4. A label 66 or instruction sheet 67 for a prescription or OTC medication box or container 68 shown in FIG. 8.

It is understood that the software for generating the calendars, grids and lists disclosed in this application may be stored on a local computer or accessed by the local computer from a remote computer or server through a communication network or the Internet.

The preferred embodiment of the present invention is a customized calendar, grid, or list displays the day of the week and/or date of the month and/or time of day that the medication is prescribed for this patient. When a customized calendar format is utilized, the preferred embodiment has the medication schedule integrated into the calendar. See FIGS. 4, 6 and 8. For the purposes of the present invention any reference to a “calendar” includes any calendar like format, any grid and any listing of any of the components of day, date and time of recommended dosages.

The present invention allows for varying dosages of medication throughout the drug or medication cycle. An example of this application is an antibiotic. The physician may prescribe that the patient “double up” on the medication for some number of days at the outset, then revert to a single dosage for the remainder of the recommended cycle. The present invention can accommodate any variation of dosages through the customization process.

In another embodiment, the size of the customary label is reduced to make room for a second label containing a calendar using any combination of day, date and time to encourage compliance with the recommended dosage schedule. With the present invention some pharmacies, label manufacturers, drug companies, vitamin or supplement suppliers and medication companies may wish to enlarge the label for easier reading of the calendar, grid or list. They may wish to dispense the medication in a larger container to be able to accommodate a larger, easier to read label.

Another embodiment of the present invention may be especially useful for elderly patients. The pharmacist can ask the patient what reminders coincide with the scheduled dosage times. These personalized reminders can be input by the pharmacist into the calendar matrix to further personalize the calendar, grid or list for that patient. See blocks 50 and 52 of FIG. 3. These reminders could be anything that would serve to jog the memory of the patient. The patient will be more likely to comply with the schedule if it is customized to something that will serve as a reminder of the proper dosage schedule. For example, the reminders may be “take during evening news”, or other customized reminder.

The present invention includes any combination of some or all of the components of day, date and time on any label or information sheet that would accompany a prescription or OTC medication. In one embodiment, the information sheet 60, 67 includes a light tack adhesive (similar to Post-It® notes) on an edge of the sheet 60, 67. This allows the sheet 60, 67 to be displayed at a suitable place to remind the patient his/her medication schedule, such as on a mirror, cabinet, refrigerator, or the like.

OTC “Over the Counter”

As discussed above, the present invention can be utilized for over the counter “OTC” medications. For the purposes of the present invention “OTC medications” can include any non-prescription medicine, vitamins and/or supplements intended to enhance the health of a customer or patient. The present invention is provided by the medication supplier, manufacturer, retail store and/or pharmacy. If the drug manufacturer or supplier uses the present invention, they could create a ‘generic’ label or information sheet to accompany the medication on or in the package that contains the medicine. In this embodiment, the calendar, grid, or list would be left blank on the day, date, and/or time as appropriate. See sheet 60 in FIG. 7. The recommended dosages and patient information are included during or after the sale, on the generic calendar as appropriate. The patient or pharmacist would fill in the grid starting with the 1^{st} dosages recommended start day and/or date and/or time. This would personalize the calendar or grid to the patient and the medication. This will encourage better compliance with the recommended dosages. For the purposes of the present invention any reference to ‘pharmacist’ can include any person at a retail establishment or facility that sells or administers medication, either OTC or prescription, that can assist the patient or customer with their medication. This could include clerks, assistants or interns as well as others.

In another embodiment, the pharmacist inputs patient data for multiple prescriptions along with the recommended OTC medication's dosage schedule into a label and/or information sheet printing system. The printed calendar, grid, or list of the dosage schedule is affixed to the medicine container and/or package in which the medication is delivered. The customized calendar, grid or list may also be printed on an information sheet for the patient to use.

In one embodiment, a customer/patient may access a remote web site and enter information related to prescriptions and/or the OTC product. The calendar, grid or list is then generated and either printed out or stored “on-line” at a remote site or stored on the customer/patient's computer for compliance tracking.

These various embodiments of the present invention serve as a reminder to the patient of when the last dosage or application was administered and when the next dosage or application is recommended. It also serves as a compliance booster in which the patient is more likely to achieve full compliance by having the reminders. When patients fully adhere to the medication's recommended schedule, it helps the medication and/or drug to be more effective. It is understood that these OTC and prescription embodiments may use any of the markings discussed below to keep track of the medications taken.

Description of Marks

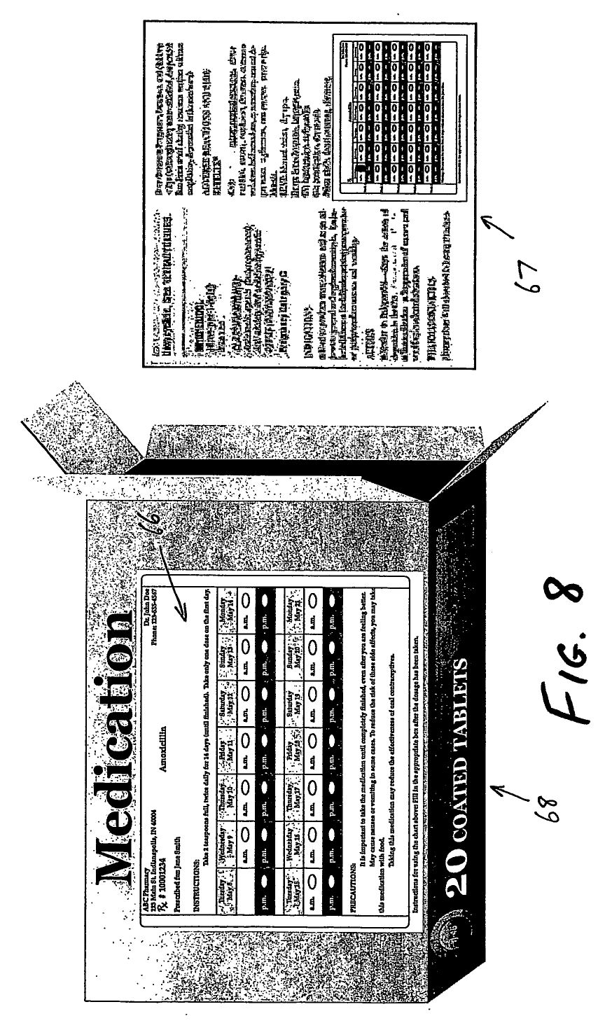

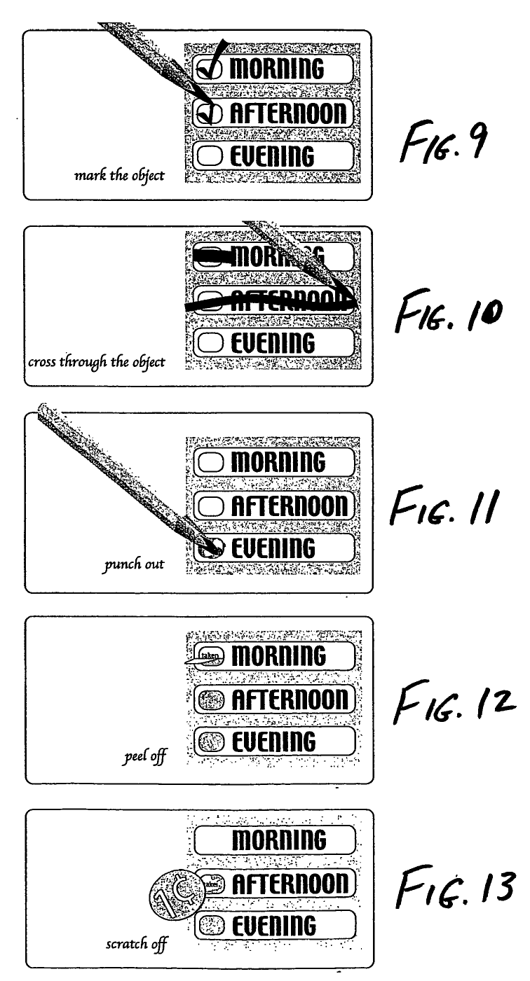

The present invention allows for various embodiments of objects and markings to be used on the calendar, grid or list. These objects and markings serve as a reminder and serve to record the compliance of the patient taking the medication. Various embodiments of the object can include boxes, circles, ovals etc. Someone skilled in the art may wish to incorporate other objects or markings to enhance compliance and keep records of that compliance. The present invention can include all types of reminder objects and compliance markers. Some of the illustrated embodiments include:

| | |
|---|---|
| Patient can make a mark in the object or fill it in. | see FIG. 9 |
| Patient can cross through the object | see FIG. 10 |
| Patient can punch out or tear off the object | see FIG. 11 |
| Patient can peel off the object | see FIG. 12 |
| Patient can scratch off (like lottery ticket) | see FIG. 13 |

Although the invention has been described in detail with reference to certain illustrated embodiments, variations and modifications exist within the scope and spirit of the present invention as described and defined in the following claims.

1. A medication reminder and compliance method comprising:
generating information related to a medication to be taken by a person;
generating a calendar including daily dosage information for specifically identified days; and
combining the calendar and the medication information on a single sheet to be referenced by the person.

2. The method of claim 1, wherein the single sheet is a label configured to be attached to a medication container.

3. The method of claim 1, wherein the single sheet is a medication information sheet.

4. The method of claim 1, wherein daily dosage information related to a plurality of different medications is included on the calendar.

5. The method of claim 1, wherein the calendar includes indicia useable by the person to indicate when particular medication dosages are taken as scheduled.

6. The method of claim 5, wherein the indicia includes at least one of a plurality of check boxes, time of day designations, punch-out portions, peel-off portions, and scratch-off portions.

7. The method of claim 1, wherein the calendar includes separate daily dosage information for each day that the medication is scheduled to be taken, each day being referenced by a specific date on the calendar.

8. The method of claim 1, wherein each day on the calendar includes dosage information representing the time that a particular dosage is to be taken.

9. The method of claim 1, wherein the medication information includes instructions for taking the medicine.

10. The method of claim 1, wherein the medication information includes at least one of the person's name, a drug name, a pharmacy name, and a doctor's name.

11. The method of claim 1, wherein the medication information includes a list of precautions related to the medication.

12. The method of claim 1, wherein the calendar includes one of a grid of days and a list of days with associated daily dosage information.

13. The method of claim 1, wherein the person generates the single sheet using a remote computer to access a main computer via a communication network.

14. A medication reminder and compliance method comprising:
selecting a number of days duration that a person is scheduled to take a medication;
selecting a start date for the medication;
selecting a number of doses of the medication to be taken by the person each day; and
generating a date specific calendar including daily dosage indicators for each day for the medication based on the selected steps.

15. The method of claim 14, wherein the step of selecting the number of days duration for the medication includes the step of selecting from a menu listing number options to select.

16. The method of claim 14, further comprising the step of identifying any of the days which require an altered daily dosage, and modifying the daily dosage for each day identified during the identifying step.

17. The method of claim 14, wherein the generating step includes the step of displaying the calendar on a display, modifying the calendar if necessary, and printing the calendar.

18. The method of claim 14, further comprising the step of generating information about the medication, and combining the medication information with the date specific calendar on a single reference sheet.

19. The method of claim 18, wherein the single reference sheet is a label configured to be attached to a medication container.

20. The method of claim 18, wherein the single reference sheet is a medication information sheet.

21. The method of claim 18, wherein the medication information includes instructions for taking the medicine.

22. The method of claim 18, wherein the medication information includes at least one of a patient name, a drug name, a pharmacy name, and a doctor's name.

23. The method of claim 18, wherein the medication information includes a list of precautions related to the medication.

24. The method of claim 14, further comprising repeating the three selecting steps for a plurality of different medications, the generating step including daily dosage information related to the plurality of different medications on the calendar.

25. The method of claim 14, wherein the calendar includes indicia useable by the person to indicate when particular medication dosages are taken as scheduled.

26. The method of claim 25, wherein the indicia includes at least one of a plurality of check boxes, time of day designations, punch-out portions, peel-off portions, and scratch-off portions.

27. The method of claim 14, wherein the calendar includes separate daily dosage information for each day that the medication is to be taken, each day being referenced by a specific date on the calendar.

28. The method of claim 14, wherein each day includes dosage information representing the time that a particular dosage is to be taken.

29. The method of claim 14, wherein the calendar includes one of a grid of days and a list of days with associated daily dosage information.

30. The method of claim 14, wherein the person generates the calendar using a remote computer to access a main computer via a communication network.

31. A medication reminder and compliance apparatus comprising:
means for selecting a number of days duration that a person is scheduled to take a medication;
means for selecting a start date for the medication;
means for selecting a number of doses of the medication to be taken by the person each day; and
means for generating a date specific calendar including daily dosage indicators for each day for the medication is scheduled to be taken.

32. The apparatus of claim 31, further comprising means for identifying any of the days which require an altered daily dosage, and means for modifying the daily dosage for each day identified during the identifying step.

33. The apparatus of claim 31, wherein the generating means includes means for displaying the calendar on a display, means for modifying the calendar if necessary, and means for printing the calendar.

34. The apparatus of claim 31, further comprising means for generating information about the medication, and means for combining the medication information with the date specific calendar on a single reference sheet.

35. The apparatus of claim 34, wherein the single reference sheet is a label configured to be attached to a medication container.

36. The apparatus of claim 34, wherein the single reference sheet is a medication information sheet.

37. The apparatus of claim 34, wherein the medication information includes instructions for taking the medicine.

38. The apparatus of claim 34, wherein the medication information includes at least one of a patient name, a drug name, a pharmacy name, and a doctor's name.

39. The apparatus of claim 34, wherein the medication information includes a list of precautions related to the medication.

40. The apparatus of claim 31, wherein the calendar includes indicia useable by the person to indicate when particular medication dosages are taken as scheduled.

41. The apparatus of claim 40, wherein the indicia includes at least one of a plurality of check boxes, time of day designations, punch-out portions, peel-off portions, and scratch-off portions.

42. The apparatus of claim 31, wherein the calendar includes separate daily dosage information for each day that the medication is to be taken, each day being referenced by a specific date on the calendar.

43. The apparatus of claim 31, wherein each day includes dosage information representing the time that a particular dosage is to be taken.

44. The apparatus of claim 31, wherein the calendar includes one of a grid of days and a list of days with associated daily dosage information.

45. The apparatus of claim 36, wherein the information sheet includes a light tack adhesive to permit the information sheet to be removably attached to a surface.
